(19) United States
(12) Patent Application Publication
(10) Pub. No.: US 2015/0279055 A1
(43) Pub. Date: Oct. 1, 2015

(54) MIPMAP COMPRESSION

(71) Applicants: NIKOS KABURLASOS, Lincoln, CA (US); YOAV HAREL, Folsom, CA (US); BENJAMIN R. PLETCHER, Mather CA, CA (US)

(72) Inventors: NIKOS KABURLASOS, Lincoln, CA (US); YOAV HAREL, Folsom, CA (US); BENJAMIN R. PLETCHER, Mather CA, CA (US)

(21) Appl. No.: 14/229,826

(22) Filed: Mar. 28, 2014

(51) Int. Cl. G06T 7/40; G06T 9/00; G06T 5/00

(52) U.S. Cl. CPC G06T 7/403; G06T 7/407; G06T 5/002; G06T 7/408; G06T 9/00

(57) ABSTRACT

A system and method are described herein. The method includes fetching a portion of a first level of detail (LOD) and a delta. A portion of a second LOD is predicted using the portion of the first LOD. The second LOD is reconstructed using the predicted portion of the second LOD and the delta.

### BACKGROUND ART

In computer graphics, an object may be rendered by first rendering the geometry of the object, then applying a texture map to the object geometry. In some cases, the object includes polygons that form a mesh. The texture map may be applied to the polygonal mesh. The texels of the texture map may not have a one-to-one correspondence with the pixels of the computer screen. Accordingly, the texels may be sampled in order to determine the color of a pixel of the computer screen.

### BRIEF DESCRIPTION OF THE DRAWINGS

FIG. 1 is a block diagram of a computing device that may execute mipmap compression;

FIG. 2 is a diagram illustrating a level of detail (LOD) prediction;

FIG. 3 illustrates a scheme for efficient storage of a delta and LOD on a device;

FIG. 4A is a process flow diagram of a method for pre-processing LOD pairs;

FIG. 4B is a block diagram showing tangible, non-transitory computer-readable media that stores code for mipmap compression.

FIG. 5 is a process flow diagram of a method for fetching LOD data from memory;

FIG. 6A illustrates a compressed LOD 4×4 block in BC-1 format;

FIG. 6B illustrates a compressed LOD 4×4 block in BC-2 format;

FIG. 7 is a block diagram of an exemplary system 700 that executes mipmap compression; and

FIG. 8 is a schematic of a small form factor device in which the system of FIG. 7 may be embodied.

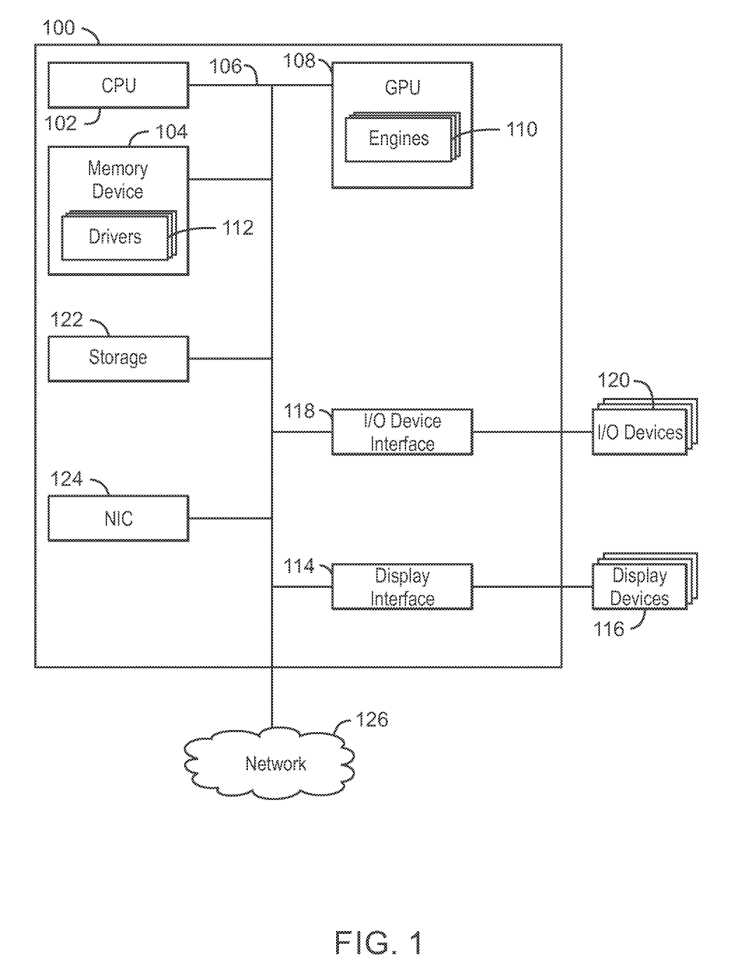

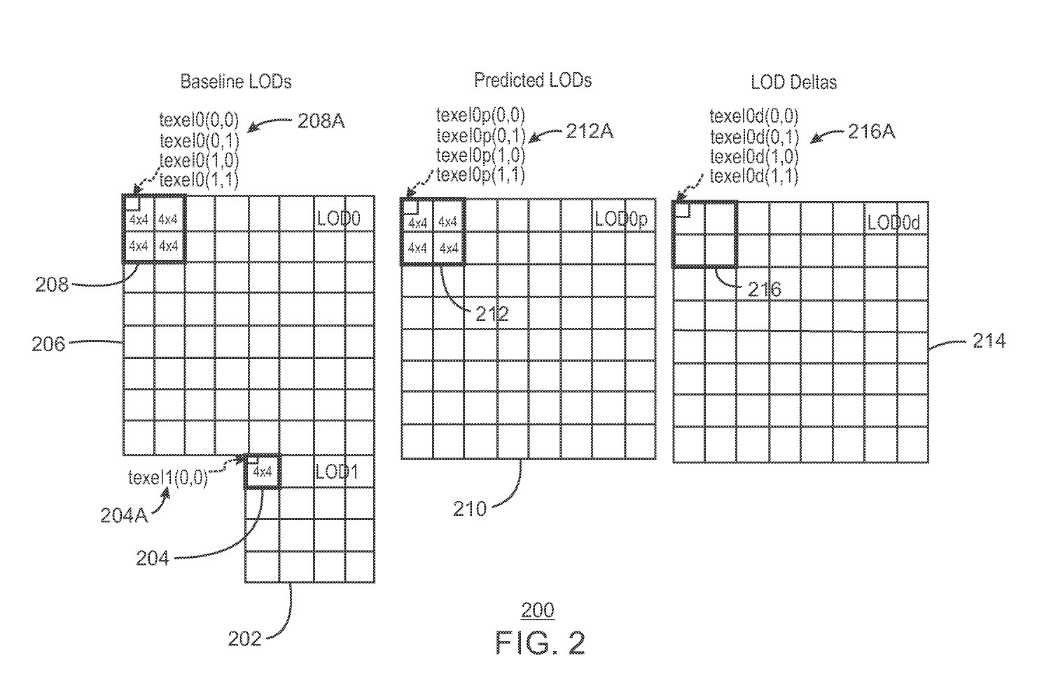

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

To compute a color value for a pixel of a computer screen, an area of the texture map is sampled. In some cases, the smallest unit of the texture map is known as a texel. The area of the texture map sampled is dependent upon the shape of the pixel, and may be known as a pixel footprint. For each pixel, the area sampled to compute the pixel color may change in shape and number of texels. In some cases, the number of texels sampled by each screen pixel is dependent upon the distance of each texture mapped polygon from the screen pixel, as well as the angle of each texture mapped polygon with respect to the screen pixel. The texels used to determine the color of each screen pixel may be filtered in order to improve the quality of the resulting image. Even when the sampled textures are filtered, the resulting image may include undesirable distortions and artifacts, also known as aliasing.

Filtering techniques such as bilinear filtering and trilinear filtering are isotropic in that both techniques sample the texture mapped polygon in a uniform fashion, where the shape of the area is the same in all directions. In particular, bilinear filtering determines a color of the pixel by interpolating the closest four texels to the pixel center in an area of the texture mapped polygon sampled by the pixel. Trilinear filtering uses bilinear filtering on the two closest Multum in parvo map (mipmap) levels, and then interpolates those results to determine the pixel color. Mipmaps may be used to reduce aliasing and increase rendering speed. In some cases, the mipmaps are a pre-calculated collection of images that are optimized for use at different depths in the rendered image. A level of detail (LOD) represents a pre-filtered image within the mipmap, with each LOD at a different depth of the image.

Each time a texture is applied onto a rendered geometry when trilinear filtering is employed, the appropriate LODs are fetched from memory, filtered, and then applied on to the rendered geometry. Fetching textures may impose a significant tax on system input/output (I/O), as applications often use a large number of textures and mipmaps. Even though textures are often compressed lossily, which can alleviate I/O bottlenecks, uncompressed textures are often used to avoid the visual degradation which is often observed with compressed textures. Using the uncompressed textures may aggravate memory I/O bottlenecks, and ultimately hurt rendering performance.

Embodiments described herein enable mipmap compression. A first LOD and a delta may be fetched from memory. A second LOD is then calculated using the first LOD and the delta. In some cases, a portion of the first LOD and the delta are stored in the same cacheline and fetched from memory at the same time. A portion of the second LOD that correlates to the portion of the first LOD is calculated or predicted using the portion of the first LOD. The second LOD is then generated using the calculated prediction of the second LOD and the delta.

In this manner, the correlation of mipmap LODs may be used to achieve a high degree of texture mipmap compression when this correlation exists. Fetching one LOD from system memory, and then enabling the hardware to reproduce another LOD of the same mipmap enables LOD reproduction to be performed in a lossily fashion. In a subsequent pass, the texture sampler hardware can fetch from memory the deltas between a reproduced LOD and the original LOD, so as to ultimately achieve a lossless reproduction of the original LOD. As a result, fetching a large LOD from memory is essentially replaced by a lossy on-the-fly reproduction of the LOD, then fetching from memory the deltas of that LOD and using its lossy reproduction to achieve a lossless LOD reproduction. Given that colors of LODs of the same mipmap are typically correlated, LOD color deltas may often be small enough to be stored in fewer bits than the original LOD. Hence, the present techniques can often achieve a significant reduction of I/O bandwidth, while also improving graphics processing unit (GPU) and system memory power consumption and performance.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may execute mipmap compression. The computing device 100 may be, for example, a laptop computer, desktop computer, ultrabook, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. The CPU may include a cache. Furthermore, the computing device 100 may include more than one CPU 102.

The computing device 100 may also include a graphics processing unit (GPU) 108. As shown, the CPU 102 may be coupled through the bus 106 to the GPU 108. In embodiments, the GPU 108 is embedded in the CPU 102. The GPU may include a cache, and can be configured to perform any number of graphics operations within the computing device 100. For example, the GPU 108 may be configured to render or manipulate graphics images, graphics frames, videos, or the like, to be displayed to a user of the computing device 100. The GPU 108 includes plurality of engines 110. In embodiments, the engines 110 may be used to perform mipmap compression. In some cases, the engines include a Sampler unit, which may be referred to as a Sampler. The Sampler is a portion of the GPU that samples textures from the mipmaps to be applied to the object geometry. The Sampler may be a hardware unit or a block of software.

The memory device 104 can include random access memory (RAM), read only memory (ROM), flash memory, or any other suitable memory systems. For example, the memory device 104 may include dynamic random access memory (DRAM). The memory device 104 may also include drivers 112. In embodiments, the mipmaps stored in memory are targeted for compression, taking advantage of the color correlation which typically exists between different LODs of the same mipmap. Although the present techniques are discussed in relation to uncompressed textures, the present techniques can be applied to compressed textures as well. Specifically, many compressed texture formats, such as BC-1 or BC-2, contain information related to base colors or alpha which would generally have the same degree of correlation across LODs as uncompressed texture colors. Thus, the present techniques can be applied to any data format that exhibits color correlation across LODs.

Prediction and reconstruction is applied to LODs of the same mipmap using the correlation between different LODs of the same mipmap to more efficiently compress mipmaps, reduce I/O bandwidth, and improve GPU power/performance. Many graphics applications tend to use a large number of textures and mipmaps, which often stresses the I/O capabilities of a platform and may introduce performance bottlenecks. To alleviate that, compressed textures are often used, but better compression often means lossy compression. Initially, the prediction and reconstruction described herein achieves a lossy reconstruction of the LODs. Lossy texture compression may introduce visual artifacts and, as a result, users often opt to use uncompressed textures, which makes it likelier to create I/O related performance bottlenecks. Furthermore, support for different compression formats such as block compression (BC) and Adaptive Scalable Texture Compression (ASTC), is fragmented across platforms and users often choose to use uncompressed textures to ensure their applications be used across all platforms. By adding LOD deltas or residues, a lossless reconstruction of the original mipmap can be achieved. In some cases, 50%-75% compression may be achieved when the present techniques are applied to uncompressed static textures. The use of compressed mipmaps can achieve further texture compression.

The CPU 102 may be linked through the bus 106 to a display interface 114 configured to connect the computing device 100 to display devices 116. The display devices 116 may include a display screen that is a built-in component of the computing device 100. The display devices 116 may also include a computer monitor, television, or projector, among others, that is externally connected to the computing device 100.

The CPU 102 may also be connected through the bus 106 to an I/O device interface 118 configured to connect the computing device 100 to one or more I/O devices 120. The I/O devices 120 may include, for example, a keyboard and a pointing device, wherein the pointing device may include a touchpad or a touchscreen, among others. The I/O devices 120 may be built-in components of the computing device 100, or may be devices that are externally connected to the computing device 100.

The computing device also includes a storage device 122. The storage device 122 is a physical memory such as a hard drive, an optical drive, a thumbdrive, an array of drives, or any combinations thereof. The storage device 122 may also include remote storage drives. The computing device 100 may also include a network interface controller (NIC) 124 configured to connect the computing device 100 through the bus 106 to a network 126. The network 126 may be a wide area network (WAN), local area network (LAN), or the Internet, among others.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

As discussed above, mipmaps are often used in trilinear texture filtering to reduce aliasing. A mipmap includes any number of LODs, and each LOD may be a bitmap image. Each mipmap may be numbered from 1 to N, with N being the total number of mipmaps. Typically, LOD0 is the largest LOD, followed by LOD1, LOD2, etc. When the texture is applied to a rendered geometry, the appropriate pair of LODs is selected, such as LOD0 and LOD1, depending on the depth of the rendered geometry. The depth of the geometry where the texture will be applied is between the depths of the texels of the mipmap pair. For example, a portion of texels may be selected in LOD0 based on the position of the pixel that is currently being shaded, and linear filtering may be performed on these texels. The same process is repeated with a portion of texels of LOD1. Linear interpolation is performed on the colors which were produced by filtering the portion of LOD0 and the portion of LOD1. In some cases, the portions may be a 2×2 subspan of texels. Although the present techniques are described using an LOD0/LOD1 pair, the same techniques can be applied to all other LOD pairs in the mipmap, such as LOD1/LOD2, LOD2/LOD3, etc.

FIG. 2 is a diagram 200 illustrating LOD prediction. A square represents a baseline LOD1 202. The LOD1 202 includes a 4×4 portion of texels 204. The 4×4 portion of texels 204 is located at the top left corner of the LOD1 202. Another larger square represents a baseline LOD0 206. The baseline LOD0 206 includes an 8×8 portion of texels 208. The 8×8 portion of texels 208 is located at the top left corner of the LOD0 206. As used herein, a baseline version of an LOD is a full, typical version of the LOD, either compressed or uncompressed.

When the 4×4 portion of texels 204 of LOD1 202 is compared to the 8×8 portion of texels 208 of LOD0 206, the colors of the 8×8 portion of texels 208 may correlate to the 4×4 portion of texels 204. Accordingly, a texell 204A may correlate to a texel0 208A. In some cases, the texel0 208A may be further divided into segments that correlate to segments of the texell 204A.

When a texture sampler is to perform any filtering technique to an LOD0/LOD1 pair, the sampler fetches the 4×4 portion of texels 204. The sampler uses the fetched 4×4 portion of texels 204 of LOD1 202 to make a lossy prediction of the child 8×8 portion of texels 208 of LOD0 206. Accordingly, another square represents a predicted LOD0 210, with a predicted child 8×8 portion of texels 212. The predicted child 8×8 portion of texels 212 includes a predicted texel 212A.

The sampler also fetches from memory pre-calculated deltas or residues for the 8×8 portion of texels 208 of LOD0 206, and used them with the predicted 8×8s portion of texels 212 to losslessly generate original LOD0 8×8s 208 that it needs to perform traditional texture sampling. Accordingly, a square represents a delta LOD0d 214, with a delta 8×8 portion of texels 216. The delta 8×8 portion of texels 216 includes a delta texel 216A. Once the portion of texels 204 of LOD1 202 and the delta texels 216A have been fetched from memory, the 8×8 portion of texels 208 can be generated losslessly and texture filtering can proceed normally. Thus, the Sampler fetches LOD0 deltas from memory and then calculates the remainder of the LOD0 color information locally.

The static texture mipmaps described herein can be loaded from memory or computed by a driver when the graphics application is launched. Using FIG. 2 as an example, assume that an application is to render a texture with a depth between the depths represented by LOD0 206 and LOD1 202. For simplicity, only LOD0 206 and LOD1 202 are shown, however a mipmap may include any number of LODs. In some cases, the LODs can be loaded from memory or computed by a driver at run time of the application. A driver can then pre-processes the mipmap in order to generate a prediction of LOD0 represented by the LOD0p 210. The LOD0p 210 is calculated using the 4×4 portion of texels 204 of LOD1 202 as seeds. The predicted child 8×8 portion of texels 212 of LOD0p 210 may generally be approximately predicted from the 4×4 portion of texels 204 of LOD1 202, since their colors are typically correlated. Specifically, baseline texel 208A includes segments texel0(0,0), texel0(0,1), texel0(1,0) and texel0(1,1) of LOD0 206, which are likely to hold similar color values as texel 204A of LOD1 202, which includes texel1(0,0). Various prediction algorithms can be used. The “smarter” the algorithm, the more accurate the prediction may be. No matter the prediction algorithm, it is likely that this prediction would be lossy. In other words, this prediction will not be able to predict the intended LOD0 texels 212 with 100% accuracy.

For example, a simple prediction scheme would be to assume that each of the predicted LOD0 texels 212A, which includes segments texel0p(0,0), texel0p(0,1), texel0p(1,0) and texel0p(1,1) are the same as the texel 204A, which includes segment texel1(0,0). Accordingly,

texel0p(0,0)=texel1(0,0)

texel0p(0,1)=texel1(0,0)

texel0p(1,0)=texel1(0,0)

texel0p(1,1)=texel1(0,0)

As simple as this prediction scheme may be, it has a chance of being relatively close when compared to actual color correlations between LOD0 and LOD1, since the predicted LOD0 texels 212 are generally correlated to the corresponding texels 204 of LOD1. However, more elaborate prediction schemes may also be used.

Once the driver has generated the predicted LOD0p 210 at runtime or launch time of the graphics application, it can then subtract the color values in LOD0p 210 from the original baseline LOD0 206. The driver can then generate the LOD delta values illustrated by LOD0d 214. In other words:

texel0d(0,0)=texel0p(0,0)−texel0(0,0)

texel0d(0,1)=texel0p(0,1)−texel0(0,1)

texel0d(1,0)=texel0p(1,0)−texel0(1,0)

texel0d(1,1)=texel0p(1,1)−texel0(1,1)

Because LOD colors are often correlated, it is very likely that the delta texel values calculated above will be small values which can fit in fewer bits relative to the bits used to store the original LOD0. For example, R8G8B8A8_UNORM is a common texture format where each of the Red, Green, Blue, and Alpha values are stored in one byte (8 bits). Thus, using the R8G8B8A8_UNORM texture format, each texel 208 of LOD0 206 in FIG. 1 would be 4 bytes large when stored in memory. Similarly, each texel 212 of LOD0p 210 would also be 4 bytes large. However, the driver will not store these LOD0 206 or LOD0p 210 in memory, rather LOD0 206 and LOD0p 210 are used in an intermediate step, as the LOD deltas are generated. The resulting LOD0d 214 would use, for example, 0-4 bits per the Red, Green, Blue, and Alpha channel, it holds ‘delta’ color values, not absolute color values. Accordingly, when LOD0d 214 is stored in memory it will generally be stored more densely and may span a significantly reduced number of bytes or cachelines, relative to the original LOD0 206.

As the driver pre-processes the LOD0 206 in FIG. 2, it may try a range of LOD prediction schemes for LOD0 206 and finally pick the one that will be able to provide the highest level of compression of LOD0 206 into LOD0d 214. In some cases, after trying all the various LOD prediction schemes in its disposal, the driver may not be able to achieve acceptable compression for LOD0 206 with any prediction scheme, in which case the whole LOD prediction/compression scheme would be aborted for this particular mipmap. The driver will aim to predict/compress as many mipmaps as possible, even though it may not be able to compress the entire range of mipmaps that the application intends to use.

While the driver may take a certain amount of time at application launch to do the mipmap pre-processing described above, this may be limited to a maximum allowed window of time that may be acceptable to the user. In other words, it is not required for the driver to predict/compress every single mipmap that the application may use. Instead, the driver it may only compress a small enough number of mipmaps, so that the start-up latency required to preprocess these mipmaps does not impose an excessively long latency at launch that would be noticeable to the user. Even if a subset of mipmaps are pre-processed and compressed, that will still offer a power consumption and performance benefit at run time relative to the baseline case where no mipmap is compressed at all.

By the time the driver is done pre-processing all (or a subset of all) the mipmaps at application-launch, it will know which of these mipmaps could be compressed and by using which of the available LOD prediction methods. This information is saved in appropriate data structures and passed on to the GPU. To ensure maximum I/O efficiency, LOD pairs (e.g. LOD0/LOD1, LOD1/LOD2 etc) are stored in the same cachelines and fetched together. This is so the Sampler can avoid having to access separate cachelines to fetch LOD1 texels and separate cachelines to fetch LOD0d information.

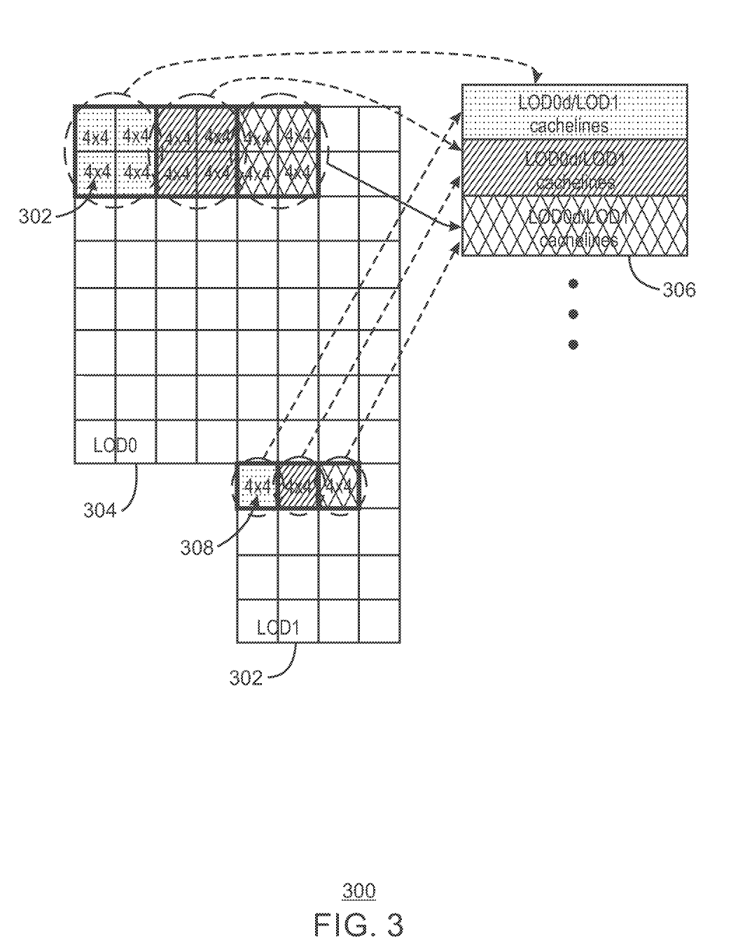

FIG. 3 illustrates an example scheme for efficient storage of a delta and LOD on a device 300. The device 300 may be storage or memory device. An LOD1 302 and a LOD0 304 represent an LOD0/LOD1 pair that is typically fetched from memory during the traditional fetching of LODs from memory. A cache consists of one or more fixed size blocks referred to as cachelines. In many cases, each LOD0 or LOD1 4×4 portion of texels is stored in a 64-byte cacheline. Accordingly, a parent LOD1 4×4 and four children LOD0 4×4s would span five cachelines worth of storage.

Using the techniques described herein, the LOD0 8×8 portion of texels 310 is to be stored in memory as a set of pre-calculated deltas, denoted by LOD0d 8×8. The color deltas will, in many cases, be small values. Thus, the LOD0d 8×8 portion of texels requires less than four cachelines of memory storage. Furthermore, the LOD1 4×4 portion of texels 308 can be compressed in a stand-alone fashion using one of the conventional color-compression technique, such as transforming the LOD to base colors and coefficients for each texel. In this manner, the fetched LOD1 4×4 may occupy less than one cacheline. In this scenario, the LOD1 4×4 308 and its “child” LOD0d 8×8 can be stored together in less than five cachelines, depending on the degree of compression that was possible to achieve for the particular texels. Moreover, the pair can be stored together as one unit or block in memory. When the Sampler fetches the LOD0/LOD1 pair, it would fetch fewer cachelines from memory which contain the compressed pair of LOD1 4×4 and LOD0d 8×8. In some cases, fewer than five cachelines are fetched, whereas five uncompressed, baseline cachelines are fetched when compression is not possible. This results in a reduction of system memory I/O bandwidth in most cases.

In embodiments, a control surface is used to determine the number of cachelines to fetch for each LOD/delta pair. For example, the Sampler may access the control surface to determine whether the five cachelines it needs to fetch for an uncompressed LOD pair would require fetching less cachelines of a compressed LOD0d/LOD1 cachelines instead. The control surface may include two or three bits per pair of LOD1 4×4 portion of texels and LOD0 8×8 portion of texels to indicate the number of compressed cachelines to fetch from memory. In examples, the control surface itself is a small enough data structure to fit in a processor cache or an integrated circuit (IC) package cache. Accordingly, the control surface may be a few kilobytes in size. In this manner, the time or power costs of accessing the control surface bits is generally low.

The present techniques may reduce the memory foot print of the mipmaps. Each LOD is generally stored (in compressed format) twice. For example, LOD1 will be stored as part of the LOD0d/LOD1 pair, also as part of the LOD1d/LOD2 pair. Given that in general, compression achieved using the present techniques would be at least 50%, storing each LOD twice in memory at least at a 50% compression rate means that the overall memory footprint required for the mipmap will stay the same as traditional techniques in the worst case scenario. More often, the present techniques achieve a 75% compression rate, which means the memory footprint will most likely shrink in size.

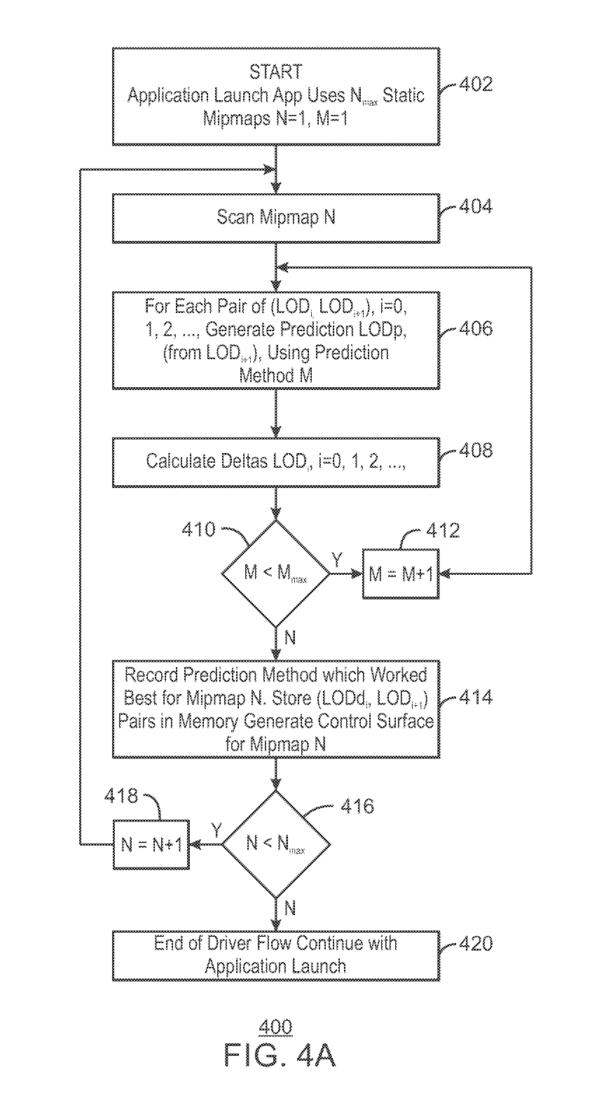

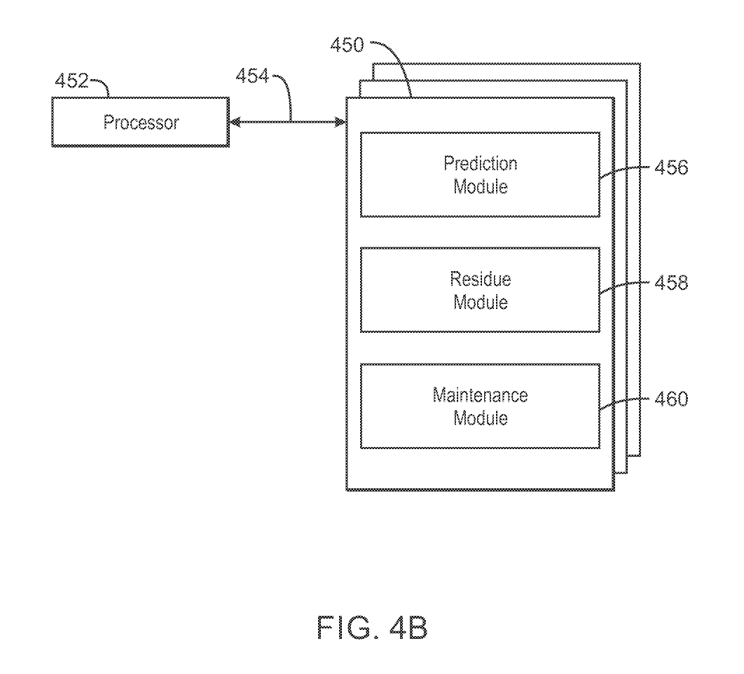

FIG. 4A is a process flow diagram of a method 400 for pre-processing LOD pairs. In some cases, a driver is used to pre-process the LOD pairs of the texture mipmaps when an application is launched. The driver may also pre-process a subset of the LOD pairs. Accordingly, at block 402, the method 400 is executed at application launch and then processes all or a subset of the static texture mipmaps (1, 2, . . . , Nₘₐₓ) that the application will use during execution, with a maximum of N mipmaps being processed. Further, a range of LOD prediction methods (1, 2, . . . , Mₘₐₓ) is selected, with a maximum of M prediction methods to be used.

At block 404, the current mipmap N is scanned. Scanning the mipmap determines each LOD of the mipmap, and the number (i) of LODs of the current mipmap. At block 406, a prediction LOD (LODpᵢ) is generated using the current prediction method M. The prediction method may be any prediction method presently known or developed in the future. At block 408, a delta LOD (LODdᵢ) is calculated for each LOD of the current mipmap N.

At block 410, it is determined if the current prediction method M is less than Mₘₐₓ. If the current prediction method M is less than Mₘₐₓ, process flow continues to block 412. If the current prediction method M is not less than Mₘₐₓ, process flow continues to block 414. At block 412, the current prediction method M is incremented by 1 (M=M+1), so that each prediction method M is applied to the current mipmap N. Process flow then returns to block 406 to apply the next prediction method M to the mipmap N.

At block 414, the prediction method M that generates the best prediction of the current mipmap N is recorded. In some cases, the best prediction method may be the prediction method that found the highest amount of correlation between the LOD pairs. Additionally, in some cases, the best prediction method may be the prediction method that found correlations between the LOD pairs that can be stored in the least amount of space. Each LODdᵢ and LODdᵢ₊₁ pair is stored in memory using the best prediction method. Further, a control surface is generated for the current mipmap N. The prediction method that achieves the best compression is identified and recorded so it can be passed on to the Sampler, along with the corresponding control surface.

At block 416, it is determined if the current mipmap N is less than Nₘₐₓ. If the current mipmap N is less than Nₘₐₓ, process flow continues to block 418. If the current mipmap N is not less than Nₘₐₓ, process flow continues to block 420. At block 418, the current mipmap N is incremented by 1 (N=N+1), so that each mipmap N is pre-processed. Process flow then returns to block 404 to scan the next mipmap N. At block 420, the driver pre-processing ends and the application launch continues.

FIG. 4B is a block diagram showing tangible, non-transitory computer-readable media 450 that stores code for mipmap compression. The tangible, non-transitory computer-readable media 450 may be accessed by a processor 452 over a computer bus 454. Furthermore, the tangible, non-transitory computer-readable medium 450 may include code configured to direct the processor 452 to perform the methods described herein.

The various software components discussed herein may be stored on one or more tangible, non-transitory computer-readable media 450, as indicated in FIG. 4B. For example, a prediction module 456 may be configured to can a mipmap, and select a best prediction method using each LOD of the mipmap. At block 458, a residue module may be configured to calculate a delta for each LOD using the best prediction method. At block 460, a maintenance module may store the delta for each LOD with a corresponding LOD in memory.

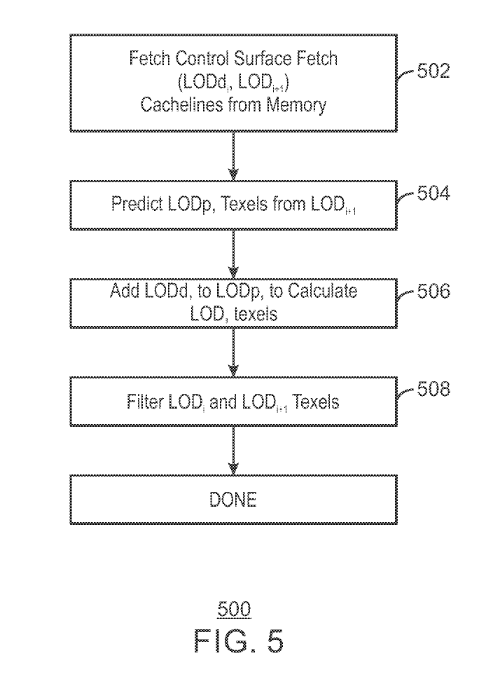

The block diagram of FIG. 4B is not intended to indicate that the tangible, non-transitory computer-readable media 450 is to include all of the components shown in FIG. 4B. Further, the tangible, non-transitory computer-readable media 450 may include any number of additional components not shown in FIG. 4B, depending on the details of the specific implementation. For example, the tangible, non-transitory computer-readable media 450 may include components to perform a method 500 as illustrated by FIG. 5.

FIG. 5 is a process flow diagram of a method 500 for fetching LOD data from memory. In some cases, the LOD data is fetched by a Sampler. At block 502, the control surface, LODdᵢ, and LODdᵢ₊₁ are fetched from memory. In some cases the LODdᵢ and LODdᵢ₊₁ are cachelines fetched from memory. At block 504, LODpᵢ texels are predicted from LODdᵢ₊₁. At block 506, LODdᵢ and LODpᵢ are summed to calculate the LODdᵢ texels. At block 508, LODdᵢ and LODdᵢ₊₁ texels are used in filtering operations.

In some cases, the method 500 is executed by the Sampler block on the fly as texels need to be fetched from different mipmaps and filtered, at execution time. The Sampler fetches compressed cachelines which contain LODᵢ₊₁ and LODdᵢ (delta) texels. The Sampler will also generate the prediction LODpᵢ texels and add them to the LODdᵢ delta values, to generate the original LOD, texels. Once the original LOD, texels are generated, the Sampler will proceed to texel filtering normally. Thus, when the full LOD pairs are generated, the generated full LOD pairs can be processed using typical filtering techniques.

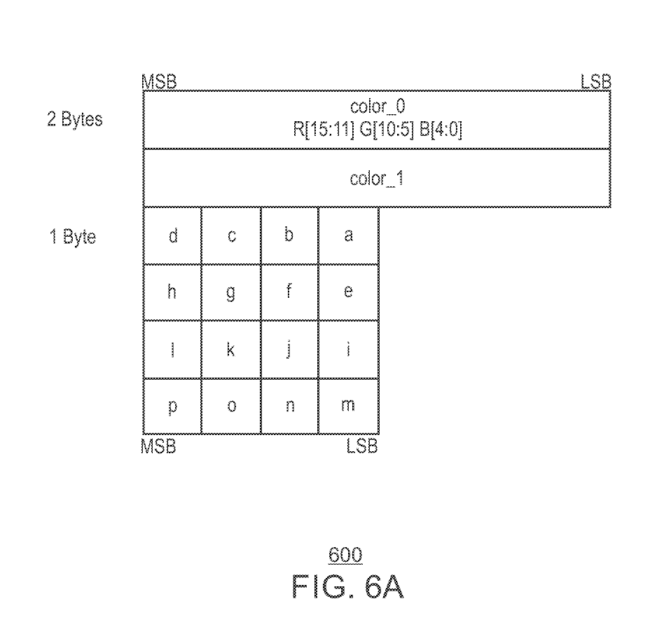

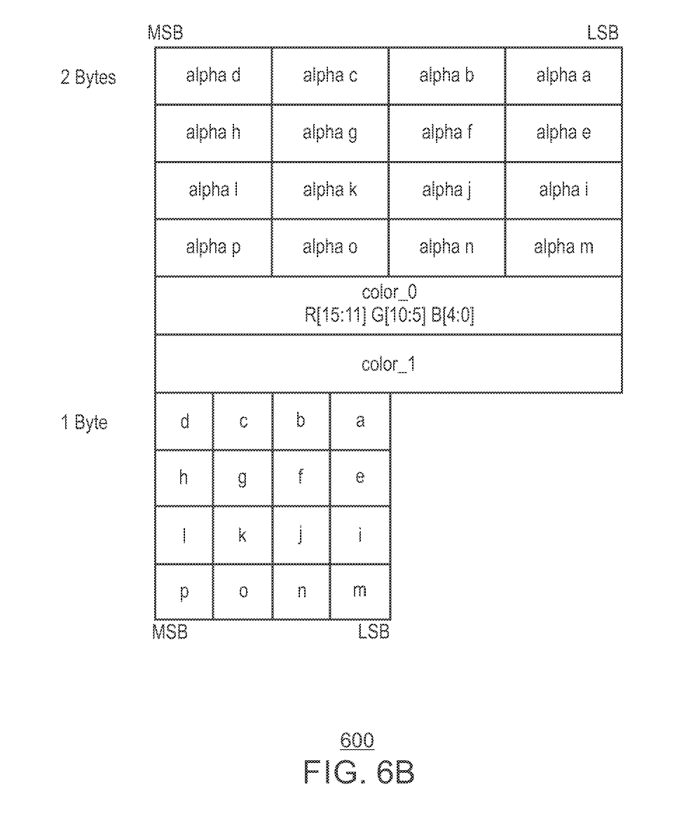

Although the present techniques have been described using uncompressed textures, the same LOD prediction and compression scheme may be applied to compressed texture formats, such as the BC-1 and BC-2 formats. FIG. 6A illustrates a compressed LOD1 4×4 block in BC-1 format 600. FIG. 6B illustrates a compressed LOD1 4×4 block in BC-2 format 650. In FIG. 6A and FIG. 6B, the Alpha and Reference Color information contained in either the first four bytes (FIG. 6A) or in the first 12 bytes (FIG. 6B) of a compressed LOD1 4×4 block could be used to predict Reference Color and Alpha values of the ‘child’ LOD0 8×8. Typically, Reference Colors and Alpha values of different LODs in a mipmap are correlated in the BC-1 and BC-2 formats. Therefore, the Reference Color and Alpha values of an LOD1 4×4 block may be used to lossily predict the Reference Color and Alpha values of a corresponding LOD0 8×8 block. Then a subtraction of the lossy prediction from the original LOD0 8×8 block is performed to determine the deltas. These deltas are later be added to the lossy prediction to losslessly reproduce the Reference Color or Alpha values of the original LOD0 8×8 block. The lossy prediction may be done on the fly by a Sampler. In this manner, mipmaps stored in a compressed texture format may be compressed further. The higher compression rates of 50% to 75% that can be obtained for uncompressed textures using the present techniques also apply to compressed textures. Specifically, the high compression rates apply to Reference Color and Alpha bytes of the compressed texture, not to the coefficient bytes. Hence the average compression achieved on the overall compressed block will generally be less than the 50% to 75% we saw earlier.

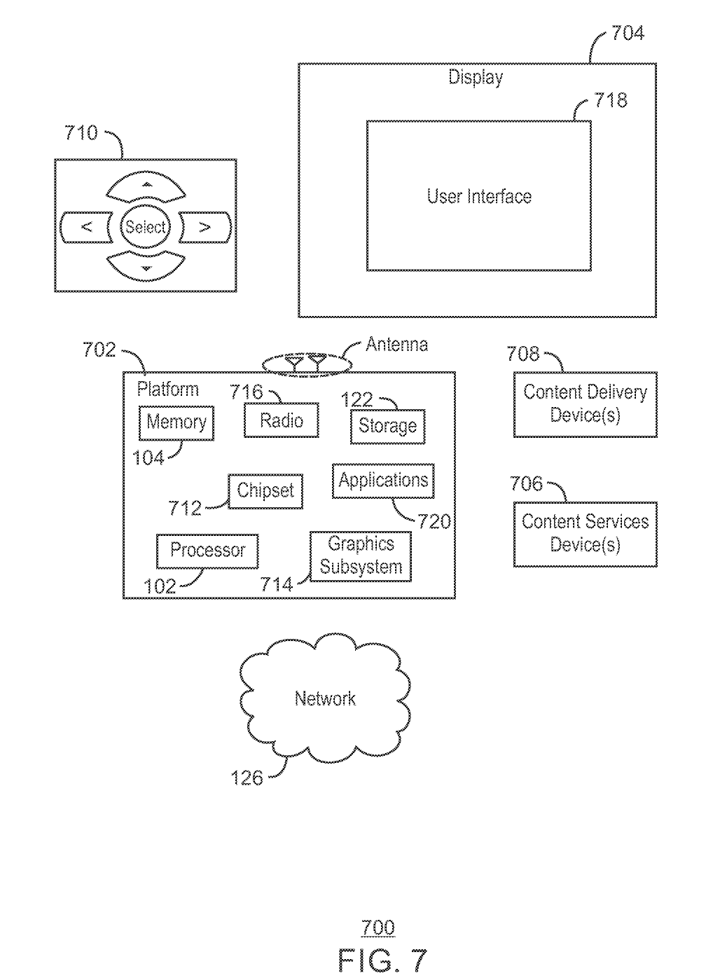

FIG. 7 is a block diagram of an exemplary system 700 that executes mipmap compression. Like numbered items are as described with respect to FIG. 1. In some embodiments, the system 700 is a media system. In addition, the system 700 may be incorporated into a personal computer (PC), laptop computer, ultra-laptop computer, server computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, a printing device, an embedded device or the like.

In various embodiments, the system 700 comprises a platform 702 coupled to a display 704. The platform 702 may receive content from a content device, such as content services device(s) 706 or content delivery device(s) 708, or other similar content sources. A navigation controller 710 including one or more navigation features may be used to interact with, for example, the platform 702 and/or the display 704. Each of these components is described in more detail below.

The platform 702 may include any combination of a chipset 712, a central processing unit (CPU) 102, a memory device 104, a storage device 122, a graphics subsystem 714, applications 720, and a radio 716. The chipset 712 may provide intercommunication among the CPU 102, the memory device 104, the storage device 122, the graphics subsystem 714, the applications 720, and the radio 716. For example, the chipset 712 may include a storage adapter (not shown) capable of providing intercommunication with the storage device 122.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes multi-core processor(s), multi-core mobile processor(s), or the like. The memory device 104 may be implemented as a volatile memory device such as, but not limited to, a Random Access Memory (RAM), Dynamic Random Access Memory (DRAM), or Static RAM (SRAM). The storage device 122 may be implemented as a non-volatile storage device such as, but not limited to, a magnetic disk drive, optical disk drive, tape drive, solid state drive, an internal storage device, an attached storage device, flash memory, battery backed-up SDRAM (synchronous DRAM), and/or a network accessible storage device. In some embodiments, the storage device 122 includes technology to increase the storage performance enhanced protection for valuable digital media when multiple hard drives are included, for example.

The graphics subsystem 714 may perform processing of images such as still or video for display. The graphics subsystem 714 may include a graphics processing unit (GPU), such as the GPU 108, or a visual processing unit (VPU), for example. An analog or digital interface may be used to communicatively couple the graphics subsystem 714 and the display 704. For example, the interface may be any of a High-Definition Multimedia Interface, DisplayPort, wireless HDMI, and/or wireless HD compliant techniques. The graphics subsystem 714 may be integrated into the CPU 102 or the chipset 712. Alternatively, the graphics subsystem 714 may be a stand-alone card communicatively coupled to the chipset 712.

The graphics and/or video processing techniques described herein may be implemented in various hardware architectures. For example, graphics and/or video functionality may be integrated within the chipset 712. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 716 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 716 may operate in accordance with one or more applicable standards in any version.

The display 704 may include any television type monitor or display. For example, the display 704 may include a computer display screen, touch screen display, video monitor, television, or the like. The display 704 may be digital and/or analog. In some embodiments, the display 704 is a holographic display. Also, the display 704 may be a transparent surface that may receive a visual projection. Such projections may convey various forms of information, images, objects, or the like. For example, such projections may be a visual overlay for a mobile augmented reality (MAR) application. Under the control of one or more applications 720, the platform 702 may display a user interface 718 on the display 704.

The content services device(s) 706 may be hosted by any national, international, or independent service and, thus, may be accessible to the platform 702 via the Internet, for example. The content services device(s) 706 may be coupled to the platform 702 and/or to the display 704. The platform 702 and/or the content services device(s) 706 may be coupled to a network 126 to communicate (e.g., send and/or receive) media information to and from the network 126. The content delivery device(s) 708 also may be coupled to the platform 702 and/or to the display 704.

The content services device(s) 706 may include a cable television box, personal computer, network, telephone, or Internet-enabled device capable of delivering digital information. In addition, the content services device(s) 706 may include any other similar devices capable of unidirectionally or bidirectionally communicating content between content providers and the platform 702 or the display 704, via the network 126 or directly. It will be appreciated that the content may be communicated unidirectionally and/or bidirectionally to and from any one of the components in the system 700 and a content provider via the network 126. Examples of content may include any media information including, for example, video, music, medical and gaming information, and so forth.

The content services device(s) 706 may receive content such as cable television programming including media information, digital information, or other content. Examples of content providers may include any cable or satellite television or radio or Internet content providers, among others.

In some embodiments, the platform 702 receives control signals from the navigation controller 710, which includes one or more navigation features. The navigation features of the navigation controller 710 may be used to interact with the user interface 718, for example. The navigation controller 710 may be a pointing device or a touchscreen device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combinations thereof. Such physical gestures can be recognized and translated into commands or instructions.

Movements of the navigation features of the navigation controller 710 may be echoed on the display 704 by movements of a pointer, cursor, focus ring, or other visual indicators displayed on the display 704. For example, under the control of the applications 720, the navigation features located on the navigation controller 710 may be mapped to virtual navigation features displayed on the user interface 718. In some embodiments, the navigation controller 710 may not be a separate component but, rather, may be integrated into the platform 702 and/or the display 704.

The system 700 may include drivers (not shown) that include technology to enable users to instantly turn on and off the platform 702 with the touch of a button after initial boot-up, when enabled, for example. Program logic may allow the platform 702 to stream content to media adaptors or other content services device(s) 706 or content delivery device(s) 708 when the platform is turned “off.” In addition, the chipset 712 may include hardware and/or software support for surround sound audio and/or high definition surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 700 may be integrated. For example, the platform 702 and the content services device(s) 706 may be integrated; the platform 702 and the content delivery device(s) 708 may be integrated; or the platform 702, the content services device(s) 706, and the content delivery device(s) 708 may be integrated. In some embodiments, the platform 702 and the display 704 are an integrated unit. The display 704 and the content service device(s) 706 may be integrated, or the display 704 and the content delivery device(s) 708 may be integrated, for example.

The system 700 may be implemented as a wireless system or a wired system. When implemented as a wireless system, the system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 7.

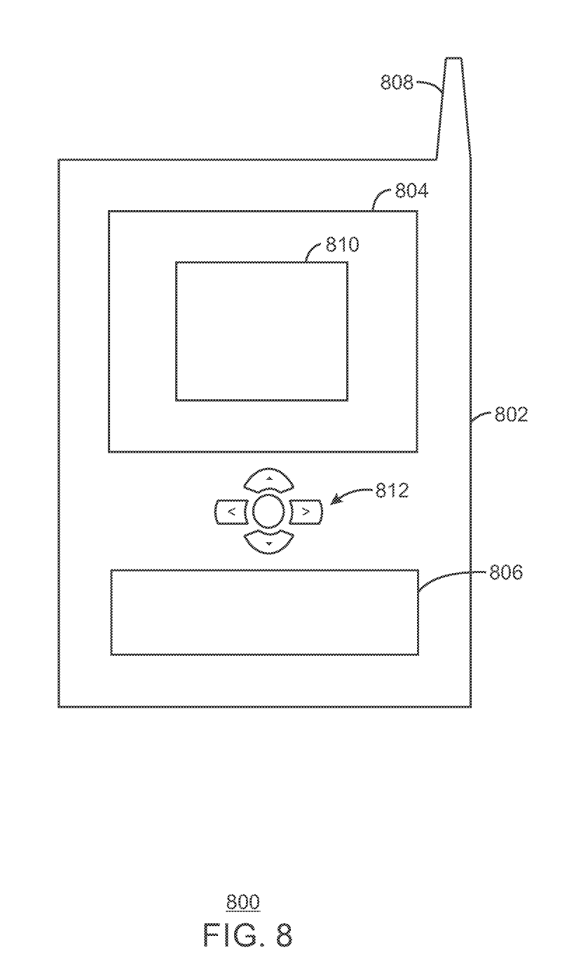

FIG. 8 is a schematic of a small form factor device 800 in which the system 700 of FIG. 7 may be embodied. Like numbered items are as described with respect to FIG. 7. In some embodiments, for example, the device 800 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, server computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wired or wireless mobile computing devices as well.

As shown in FIG. 8, the device 800 may include a housing 802, a display 804, an input/output (I/O) device 806, and an antenna 808. The device 800 may also include navigation features 812. The display 804 may include any suitable display 810 unit for displaying information appropriate for a mobile computing device. The I/O device 806 may include any suitable I/O device for entering information into a mobile computing device. For example, the I/O device 806 may include an alphanumeric keyboard, a numeric keypad, a touch pad, input keys, buttons, switches, rocker switches, microphones, speakers, a voice recognition device and software, or the like. Information may also be entered into the device 800 by way of microphone. Such information may be digitized by a voice recognition device.

### EXAMPLE 1

A method for obtaining compressed mipmaps is described herein. The method includes fetching a portion of a first level of detail (LOD) and a delta. The method also includes predicting a portion of a second LOD using the portion of the first LOD and reconstructing the second LOD using the predicted portion of the second LOD and the delta.

The delta may be pre-calculated, and reconstructing the second LOD can result in a lossless reconstruction of a mipmap. A control surface may be fetched, where the control surface is to determine a number of cachelines to fetch for the portion of the first LOD and the delta. Additionally, the portion of the second LOD is predicted using a color correlation between colors of the first LOD and the second LOD, and the predicted portion of the second LOD may be a lossy reconstruction of the second LOD. The LODs may be in a compressed format. Further, the compressed format can be block compression (BC)-1, BC-2, Adaptive Scalable Texture Compression (ASTC), or any combination thereof. Additionally, the portion of the first LOD and the delta may be stored in five or fewer cachelines of memory storage. The first LOD and the second LOD can be used as full LOD pairs fetched from memory. The portion of a first level of detail (LOD) fetched can be a 4×4 grouping of texels, and the predicted portion of the second LOD can be a 8×8 grouping of texels. Additionally, the portion may be a cacheline.

### EXAMPLE 2

A system for mipmap compression is described herein. The system includes a display, a radio, a memory, and a processor. The memory is to store instructions and is communicatively coupled to the display. The processor is communicatively coupled to the radio and the memory. When the processor is to execute the instructions, the processor is to obtain a portion of a first level of detail (LOD) and a delta from the memory, and calculate a portion of a second LOD using the portion of the first LOD. When the processor is to execute the instructions, the processor is to also generate the second LOD using the calculated portion of the second LOD and the delta.

The system may include a Sampler unit, wherein the Sampler unit is to obtain the portion of the first level of detail LOD and the delta from the memory. The processor may include an execution unit to execute the instructions. A correlation of colors between the portion of the first LOD and the portion of the second LOD can be used to obtain the delta, and a processor of the system is to reproduce the second LOD of the same mipmap in order to generate the second LOD. An initial approximation of the second LOD may be generated lossily, and a texture sampler may fetch from the memory the delta between the second LOD and an original LOD to generate the second LOD losslessly, wherein the original LOD is a baseline version of the second LOD. Moreover, generating the second LOD can be performed on-the-fly. Mipmap compression can achieve a significant reduction of input/output (I/O) memory bandwidth. The processor may be a central processing unit (CPU), or the processor may be a graphics processing unit (GPU). Additionally, the first LOD and the second LOD can be in a compressed texture format.

### EXAMPLE 3

A tangible, non-transitory, computer-readable medium comprising code is described herein. The code may direct a processor to scan the mipmap and select a best prediction method using each level of detail (LOD) of the mipmap. The code may also direct the processor to calculate a delta for each LOD using the best prediction method, and store the delta for each LOD with a corresponding LOD in memory.

A control surface may be generated for the mipmap, or the mipmap may be a static mipmap. Further, the mipmap can be compressed at runtime of an application. Additionally, the delta and the corresponding LOD can be stored in a single cacheline, or the delta and the corresponding LOD can be stored in a fewer cachelines than an LOD pair. A footprint of the memory can be reduced when compared to a memory footprint of an LOD pair. Additionally, the LODs may be in a compressed format, or the compressed format can be block compression (BC)-1, BC-2, Adaptive Scalable Texture Compression (ASTC), or any combination thereof. Further, the I/O memory bottlenecks can be reduced.

### EXAMPLE 4

An apparatus for mipmap compression is described herein. The apparatus includes a means to fetch a level of detail (LOD) from a memory, where a portion of a first LOD and a delta is fetched from the memory. The apparatus also includes a means to predict a portion of a second LOD using the portion of the first LOD and calculate the second LOD using the predicted portion of the second LOD and the delta.

The apparatus may include a means to generate a plurality of deltas for the mipmap at runtime. The second LOD can be predicted lossily. Calculating the second LOD using the predicted portion of the second LOD and the delta may be lossless. Predicting a portion of a second LOD using the portion of the first LOD can be done on-the-fly. Additionally, the portion of the second LOD can be predicted using a color correlation between colors of the portion of the first LOD and the portion of the second LOD. The portion of the first LOD and the portion of the second LOD may be in a compressed format. Also, a power consumption can be reduced. Further, the portion of the first LOD and the portion of the second LOD can be used as full LOD pairs fetched from memory, such that texture sampling is unchanged. Moreover, the portion of the first LOD and the delta can be stored in a single cacheline.

### EXAMPLE 5

A method for mipmap compression is described herein. The method includes scanning the mipmap and selecting a best prediction method using each level of detail (LOD) of the mipmap. The method also includes calculating a delta for each LOD using the best prediction method, and storing the delta for each LOD with a corresponding LOD in memory.

A control surface may be generated for the mipmap, or the mipmap may be a static mipmap. Further, the mipmap can be compressed at runtime of an application. Additionally, the delta and the corresponding LOD can be stored in a single cacheline, or the delta and the corresponding LOD can be stored in a fewer cachelines than an LOD pair. A footprint of the memory can be reduced when compared to a memory footprint of an LOD pair. Additionally, the LODs may be in a compressed format, or the compressed format can be block compression (BC)-1,BC-2, Adaptive Scalable Texture Compression (ASTC), or any combination thereof. Further, the I/O memory bottlenecks can be reduced.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for obtaining compressed mipmaps, comprising:
fetching a portion of a first level of detail (LOD) and a delta;
predicting a portion of a second LOD using the portion of the first LOD;
reconstructing the second LOD using the predicted portion of the second LOD and the delta.

2. The method of claim 1, wherein the delta is pre-calculated.

3. The method of claim 1, wherein reconstructing the second LOD results in a lossless reconstruction of a mipmap.

4. The method of claim 1, comprising fetching a control surface, wherein the control surface is to determine a number of cachelines to fetch for the portion of the first LOD and the delta.

5. The method of claim 1, wherein the portion of the second LOD is predicted using a color correlation between colors of the first LOD and the second LOD.

6. The method of claim 1, wherein the predicted portion of the second LOD is a lossy reconstruction of the second LOD.

7. The method of claim 1, wherein the first LOD and the second LOD are in a compressed format.

8. The method of claim 7, the compressed format is block compression (BC)-1, BC-2, Adaptive Scalable Texture Compression (ASTC), or any combination thereof.

9. The method of claim 1, wherein the portion of the first LOD and the delta are stored in five or fewer cachelines of memory storage.

10. A system for mipmap compression, comprising:
a display;
a radio;
a memory communicatively coupled to the display, to store instructions; and
a processor communicatively coupled to the radio and the memory,
wherein when the processor is to execute the instructions, the processor is to:
obtain a portion of a first level of detail (LOD) and a delta from the memory;
calculate a portion of a second LOD using the portion of the first LOD;
generate the second LOD using the calculated portion of the second LOD and the delta.

11. The system of claim 10, comprising a sampler unit, wherein the Sampler unit is to obtain the portion of the first level of detail LOD and the delta from the memory.

12. The system of claim 10, wherein the processor includes an execution unit to execute the instructions.

13. The system of claim 10, wherein a correlation of colors between the first LOD and the second LOD is used to obtain the delta.

14. The system of claim 10, wherein the processor of the system is to reproduce the second LOD of the same mipmap in order to generate the second LOD.

15. The system of claim 10, wherein an initial approximation of the second LOD is generated lossily, and wherein a texture sampler is to fetch from the memory the delta between the second LOD and an original LOD to generate the second LOD losslessly, wherein the original LOD is a baseline version of the second LOD.

16. The system of claim 10, wherein the processor is a graphics processing unit.

17. A tangible, non-transitory, computer-readable medium comprising code to direct a processor to:
scan a mipmap;
select a best prediction method using each level of detail (LOD) of the mipmap;
calculate a delta for each LOD using the best prediction method; and
store the delta for each LOD with a corresponding LOD in memory.

18. The computer-readable medium of claim 17, comprising generating a control surface for the mipmap.

19. The computer-readable medium of claim 17, wherein the mipmap is a static mipmap.

20. The computer-readable medium of claim 17, wherein the mipmap is compressed at runtime of an application.

21. The computer-readable medium of claim 17, wherein the delta and the corresponding LOD are stored in a single cacheline.

22. The computer-readable medium of claim 17, wherein the delta and the corresponding LOD are stored in a fewer cachelines than an LOD pair.

23. The computer-readable medium of claim 17, wherein a footprint of the memory is reduced when compared to a memory footprint of an LOD pair.

24. The computer-readable medium of claim 17, wherein the LODs are in a compressed format.

25. The computer-readable medium of claim 23, wherein the compressed format is block compression (BC)-1, BC-2, Adaptive Scalable Texture Compression (ASTC), or any combination thereof.
